(19) United States
(12) Patent Application Publication
(10) Pub. No.: US 2017/0019259 A1
(43) Pub. Date: Jan. 19, 2017

(54) On Board Computerized System for Operating Certified Functions

(71) Applicant: THALES, COURBEVOIE (FR)

(72) Inventors: Marc Jacques Yvon GATTI, VELIZY VILLACOUBLAY (FR); Laurent Marcel Maurice BARDET, PESSAC (FR); Jean-Michael Rene ANGE, PESSAC (FR); Damien Hubert Robert JUGIE, PESSAC (FR)

(21) Appl. No.: 15/201,050

(22) Filed: Jul. 1, 2016

(30) Foreign Application Priority Data
Jul. 2, 2015 (FR) 15 01404

(51) Int. Cl. H04L 9/32

(52) U.S. Cl. CPC H04L 9/3263

(57) ABSTRACT

This system for implementing certified functions, of the type including multiple configurable resources for implementing operational applications, is characterized in that it includes means for supervising its operation, including means forming a directory for keeping available resources of the platform up to date, means (10) for detecting resources required by the operational applications to be implemented, and means for configuring/reconfiguring resources of the system and assigning them to the applications, to adapt them and their operation to the implemented operational applications.

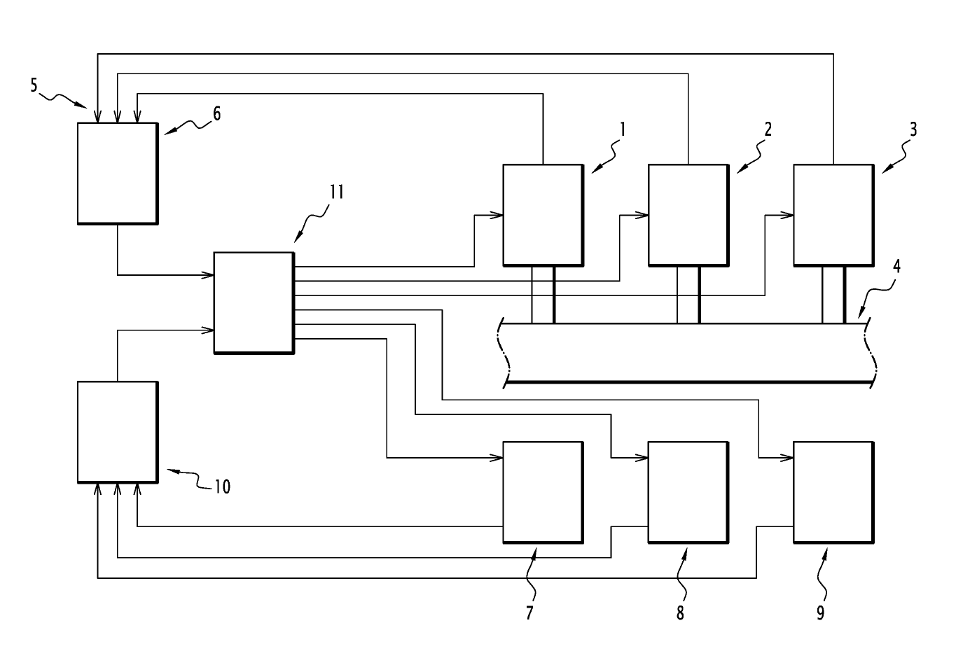

### CROSS REFERENCE TO RELATED APPLICATION

The present application is a non-provisional application claiming the benefit of FR 15 01404, filed Jul. 2, 2015, which is incorporated herein by reference in its entirety.

### FIELD OF THE INVENTION

The present invention relates to an on board computerized system for operating certified functions.

### BACKGROUND

On board computerized systems for this type of application are already known in the state of the art.

These systems then include multiple configurable resources for implementing operational applications.

Such certified functions are functions chosen to be applied in areas such as the avionics, railroad, aerospace or automobile fields.

Today, these on board computer systems are completely frozen inasmuch as from the time of construction of the system, the resources thereof are allocated to the applications.

One can then see that any alteration, even minimal, of these resources or applications results in requiring in-depth reworking of the definition of the system.

It is known that this may have extremely significant consequences, in particular in terms of redesign costs, inasmuch as the functions in question are so-called certified functions.

The aim of the invention is therefore to resolve these problems.

To that end, the invention relates to an on board computerized system for operating certified functions, of the type including multiple configurable resources for implementing operational applications, characterized in that it includes:
means for supervising its operation, including means forming a directory for updating the available resources of the system,
means for detecting resources required by the operational applications to be implemented, and
means for configuring/reconfiguring resources of the system and assigning them to the applications, to adapt them and their operation to the implemented operational applications.

According to other features of the system according to the invention, considered alone or in combination:
the configuration/reconfiguration means are suitable for controlling all of the resources in real-time;
the resources are chosen from a group of resources further comprising resources for:
   data storage,
   computation,
   information communication,
   interfacing, or
   data encryption/decryption;
the certified functions are functions chosen from one of the following fields:
   avionics,
   railroad,
   aerospace, or
   automobile.

The invention will be better understood upon reading the following description, provided solely as an example and done in reference to the appended drawing, which shows a block diagram illustrating the structure and operation of a system according to the invention.

This FIGURE shows an on board computerized system intended to implement certified functions.

More specifically, this on board computerized system is designed to carry out certified functions that may for example be chosen from the avionics, railroad, aerospace or automobile fields, where large numbers of these types of applications are found.

In the avionics field in particular, these functions may be functions applicable to the military field or civilian field, in particular in aircraft, or others.

In general, such a computerized system includes available resources, such as resources designated by references 1, 2 and 3 in this FIGURE.

These available resources may for example be data storage, computation, communication, interfacing, data encryption/decryption, etc. resources.

Indeed, any type of resource may be considered.

These available resources may for example be stored in modules, associated with one another and for example connected by means forming a data transmission network, for example designated by general reference 4 in this FIGURE.

In the on board computerized system according to the invention, means are also provided for supervising the operation of this system and its various members.

These supervising means are designated by general reference 5 in this FIGURE, and for example include means forming a directory for updating the available resources of the system,

These directory means are designated by general reference 6, and are therefore suitable for keeping a directory of resources up to date in terms of status, performance capacity, etc.

As previously indicated, these multiple configurable resources are suitable for implementing operational applications.

These operational applications are for example designated by references 7, 8 and 9 in this FIGURE.

Indeed, in the computerized system according to the invention, means are also provided, designated by general reference 10, for detecting resources required by the operational applications to be implemented.

Lastly, the on board computerized system according to the invention also includes means for configuring or reconfiguring resources of this system and assigning them to the applications, to adapt them and their operation to the implemented operational applications.

These configuration/reconfiguration means are designated by general reference 11 in this FIGURE and are therefore connected as input on the one hand to the directory means 6, and on the other hand to the detection means 10.

Based on the information thus inventoried, on the one hand regarding the resources and on the other hand regarding the applications, these configuration/reconfiguration means 11 are then suitable for assigning and adapting the available resources for the implemented operational applications.

It will be noted that this may for example be implemented by checking all of the available resources in real-time.

As previously indicated, the resources in question may be of different natures.

For example, these resources may be data storage resources, for example memories, etc., computing resources, for example using on board computers, microprocessors, etc., data communication and interfacing resources in general, making it possible to exchange data for example across or via the network, between connected entities or to the outside, for example through data encryption/decryption means.

One can then see that such a structure has a certain number of advantages in terms of its capacity to adapt to the evolution of these types of materials.

Of course, other embodiments of this system may be considered.

1. An on board computerized system for operating certified functions that include multiple configurable resources for implementing operational applications, the on board computerized system comprising:
means for supervising its operation, including means forming a directory for updating the available resources of the system;
means for detecting resources required by the operational applications to be implemented; and
means for configuring/reconfiguring the multiple configurable resources and assigning them to the operational applications to adapt them and their operation to the implemented implement the operational applications.

2. The on board computerized system according to claim 1, wherein the configuration/reconfiguration means are suitable for controlling all of the multiple configurable resources in real-time.

3. The on board computerized system according to claim 1, wherein the multiple configurable resources are selected from the group consisting of data storage, computation, information communication, interfacing, and data encryption/decryption.

4. The on board computerized system according to claim 2, wherein the multiple configurable resources are selected from the group consisting of data storage, computation, information communication, interfacing, and data encryption/decryption.
